(19) United States
(12) Patent Application Publication
(10) Pub. No.: US 2021/0403658 A1
(43) Pub. Date: Dec. 30, 2021

(54) Composition and method for active packaging and storage of fresh plant products

(71) Applicant: Helsingin Yliopisto, Helsingin yliopisto (FI)

(72) Inventors: Mari Lehtonen, Helsinki (FI); Kirsi Mikkonen, Helsinki (FI); Maija Tenkanen, Helsinki (FI)

(21) Appl. No.: 17/289,289

(22) PCT Filed: Oct. 29, 2019
(86) PCT No.: PCT/FI2019/050770

§ 371 Date: Apr. 28, 2021

(30) Foreign Application Priority Data
Oct. 29, 2018 (FI) 20185908

(51) Int. Cl. C08J 5/22; C08J 9/40; C08L 1/02; C08L 5/14; B65D 81/26

(52) U.S. Cl. CPC C08J 5/2212; C08J 9/40; C08L 1/02; C08J 2305/14; B65D 81/263; C08J 2301/02; C08L 5/14

(57) ABSTRACT

The present invention relates to a composition and method for active packaging of fresh plant products, in particular fresh plant based food products. The invention also relates to means for storage of fresh plant products and to a method for continuous production and controlled release of volatile oxidation products of lipids in packages or in the vicinity of fresh plant based goods.

### FIELD

The present invention relates to a composition and method for active packaging of fresh plant products, in particular fresh plant based food products. The invention also relates to means for storage of fresh plant products and to a method for continuous in situ production and controlled release of volatile oxidation products of lipids in packages or in the vicinity of fresh plant based goods.

### BACKGROUND

Worldwide importation and long-term storage of plant products are needed to respond to growing consumer demand on availability of wide selection of fruits, berries, vegetables, and cut flowers all year round. Long-distance transportation exposes these goods to various hazards. Therefore, transportation conditions need to be carefully tailored. Some products need to be preserved against maturation while others need to be ripened during the journey and storage. Additionally, the storage conditions immediately after harvesting and after transportation to the final destination need to be controlled for ensuring high quality goods. Special storage conditions have been designed for the industry, but often at the final stage, fruits, berries and vegetables need to be consumed shortly after purchasing.

Tissue softening and browning due to ripening and physical disturbance lead to disappealing appearance and rapid deterioration of fruits, berries, vegetables, and cut flowers. When the cell walls of plants are wounded for example by mechanical disturbance, by pathogen attack or by senescence, activation of lipid oxidizing enzymes occurs (Siedow, 1991). Disruption of cell structure brings these enzymes in contact with their substrates. Lipoxygenases (LOX) catalyse direct addition of molecular oxygen to the pentadiene double bond system in unsaturated lipids. As a result, hydroperoxides are formed. When these hydroperoxides decompose further by hydroperoxide lyases, volatile aldehydes, such as hexanal, and ketones are formed. Aldehydes and ketones having the chain lengths of six and nine carbons, e.g., hexanal, 3-hexanone, nonanal and 2-nonanone, function among others as inhibitors of phospholipase D activity, and of mycotoxins and ethylene syntheses (Siedow, 1991). Thus, they have been shown to reduce the necrosis caused by maturation and the growth of pathogens. Moreover, they may act as attractors for insect predators.

Externally applied volatile aldehydes and ketones have also been shown to reduce the growth of bacteria, yeast and fungi for example in blue berries and pome fruits (Song et al, 1996; Sholberg & Randall, 2007). Moreover, the ethylene synthesis was reduced leading to extended shelf life. Hexanoic acid was shown to reduce the growth of fungi and bacteria in fruit and vegetables (Vicedo et al, 2009; Llorens et al, 2015). However, most often the use of hexanal for shelf life extension has been studied.

Hexanal is a natural fungicide and preservative that can be utilized to prolong the storage time of various fruits and berries. Hexanal is considered as a safe aldehyde and it is allowed to be used as a flavour substance in food products (EU No 872/2012). Hexanal is a six carbon containing aldehyde which is formed during the oxidation of lipids, in particular linoleic acid. It has been shown to increase shelf-life of fruits and berries.

As stated above, hexanal is formed during the oxidation of lipids. Lipid oxidation may occur via non-enzymatic autoxidation or photoxidation, or via enzyme catalysed reactions (Schaich et al., 2013). In autoxidation, the initiation of radical chain reaction occurs generally via elevated temperature. Formed lipid radicals react with oxygen producing hydroperoxides. In photoxidation, photosensitizer absorbs low-level light energy and transforms it into chemical energy by producing either singlet oxygen or lipid radicals. In both cases, hydroperoxides are formed. Also enzymes, such as plant originating lipoxygenases, are able to catalyse formation of lipid hydroperoxides. While the formed hydroperoxides decompose further, hexanal and other oxidation products are formed.

Fruits and vegetables may be treated with hexanal either prior to harvesting or immediately after that. Pre-harvesting treatment involves spraying the plants with hexanal formulations (1-2%). Post-harvesting treatment often involves either dipping the harvested fruits or vegetables into hexanal solutions or storing them under hexanal containing atmosphere. In the latter case, hexanal is generally applied as a batch treatment in chambers. That is, fruits or berries are maintained in a chamber enriched with hexanal vapour for a certain time period prior to transportation and storage. The treatment may be repeated during the storage.

EP 14697361 A1 and U.S. Pat. No. 6,514,914 B disclose compositions for the preservation of fruits and vegetables, wherein said compositions comprise a phospholipase D inhibitor, such as hexanal, together with a compound comprising an isoprene subunit, and a component of the flavonoid biosynthetic pathway in a suitable medium. The composition may be applied to products as a spray, drench, dip, or a vapour at pre-harvest or post-harvest stage.

However, the effects of these types of treatments are rather short-term. In the batch treatments, a decrease in the vapour concentration has been shown. Continuous storage under hexanal atmosphere has thus not been feasible and the effectiveness of the treatment decreases. To maintain its concentration, additional hexanal should be incorporated to replace the consumed proportion. This could be possible under industrial conditions, but after the goods are packed and delivered to resellers, the shelf life is limited. Another option for batch treatment would be continuous presence of hexanal in the storage space or packaging.

Incorporation of hexanal into cyclodextrin inclusion complexes for controlled release and prolonged diffusion has also been studied (Almenar et al. 2007). 450-900 μmol/g of hexanal was incorporated to cyclodextrin enabling final release of 2-15 μmon air. This concentration reduced or inhibited the growth of various fungi. However, the concentration decreased gradually by 30-100% throughout 7 days of storage leading to expected affective lifetime of 1-2 weeks.

WO 2017055424 A1 discloses an antimicrobial combination of citral, hexanal, and linalool, which is included in a formulation incorporated in an active packaging material for the preservation of foodstuff, particularly fruit and vegetables.

In some studies, release of hexanal from a synthetic precursor (1,3-dibenzylethane-2-pentyl imidazolidine) entrapped in poly(lactic acid) fiber or ethylcellulose particulate carriers was investigated (Jash & Lim, 2018; Jash et al, 2018). The release of hexanal was activated by citric acid and followed for 6 hours.

Instead of inhibiting ethylene synthesis by using C6 and C9 aldehydes and ketones, some prior art attempts have focused on removal of ethylene in the post-harvest phase. For said purpose, various filtration machines and absorbent ethylene removal sachets, based on a mixture of potassium permanganate and clay, have been suggested (www.bioconservacion.com).

Some compositions containing a lipid phase and a matrix, in the presence of enzymes or photosensitizers that typically are an inherent part of the composition or are added for reasons other than initiating oxidation, have been disclosed. However, such compositions do not provide controlled release of oxidation products of lipids. For example EP 0598920 A1 discloses an emulsifier comprising soybean hemicellulose, water, coconut oil, and β-carotene, wherein the aim of the composition is to prevent oxidation.

Therefore, there exist a need to provide means for continuous production and controlled release of hexanal or other volatile ketones and aldehydes in situ, i.e. in the package or in the vicinity of fresh plant products. In particular, there exists a need to provide controlled release and continuous in situ production of hexanal for a sufficient time, such as from several days to several weeks.

The present invention provides a solution for controlled in situ production and continuous release of volatile oxidation products of lipids, in particular hexanal, from active material. Hexanal is produced via various lipid oxidation pathways in the compositions of the invention at various storage conditions. For example, the compositions or materials according to the invention may be incorporated in the packaging material, or inserted in the packages or in the storage space in the vicinity of various fresh plant products, such as berries and vegetables, to extend their shelf life. The present invention thus provides a solution to the problem of how to continuously produce and release hexanal, other volatile aldehydes, ketones, or hexanoic acid, in the packages or in the vicinity of fresh plant products.

### SUMMARY OF THE INVENTION

The invention is defined by the features of the independent claims. Some specific embodiments are defined in the dependent claims.

According to a first aspect of the present invention, there is provided a composition comprising a matrix having a lipid phase incorporated therein, wherein the lipid phase comprises an initiator enabling controlled release of oxidation products of lipids, such as volatile aldehydes, ketones, and acids, from lipids of the lipid phase.

According to a second aspect of the present invention, there is provided an active package or active material for storage of fresh plant products, particularly fresh food products, such as fruit, berries and vegetables, or cut flowers, comprising a composition comprising a matrix having a lipid phase incorporated therein, wherein the lipid phase comprises an initiator to enable controlled release of oxidation products of lipids, such as volatile aldehydes, ketones, and acids, from lipids of the lipid phase.

According to a third aspect of the present invention, there is provided a method for continuous in situ production and controlled release of oxidation of products of lipids, in particular volatile aldehydes, ketones, and acids, such as volatile C6 and C9 aldehydes, ketones, and acids, particularly hexanal, in packages or in the vicinity of fresh plant based goods, for a storage period of at least 10 days, wherein the composition according to the invention is incorporated in the package, in the packaging material, or in the storage space in the vicinity of the fresh plant based goods.

Embodiments of the invention comprise also a package comprising fresh plant based goods and the composition of the invention, as well as the use of the composition of the invention in packaging or storage of fresh plant based goods to prolong the shelf life of said goods.

The present invention is based on the finding that hexanal and other oxidation products of lipids, such as volatile aldehydes, ketones, and acids can be produced in situ in active materials and released continuously from the active material. Hexanal and other oxidation products of lipids were produced from lipids in situ via photoxidation and via enzyme catalyzed reactions. The compositions of the invention were found to continuously release hexanal and other volatile oxidation products for an extended period of time.

Considerable advantages are obtained by the invention. The compositions of the invention provide active material in which controlled in situ production and release of preservative substances, such as volatile aldehydes, ketones, and acids, is possible. Said active material is feasible to be used in consumer packaging, including primary and secondary packaging, to prolong the shelf life of various plant based goods. The present invention also provides the advantage that the plant products can be collected when they ripen but they nevertheless maintain their freshness during transportation and storage, thus providing a better sensory experience than plant products collected unripened and ripened during transportation.

The compositions and method of the invention decrease food waste and may prevent the occurrence of food-borne diseases. In addition to evident cost savings, the active materials of the invention can be made from renewable materials, which is beneficial to environment. Preferably all components of the composition can be selected from natural, non-synthetic materials. In particular, the source of hexanal or other volatile ketones and aldehydes comprises or is a natural component.

Further features and advantages of the present technology will appear from the following description of some embodiments.

### BRIEF DESCRIPTION OF THE DRAWINGS

FIG. 1 illustrates the effect of substrate (sunflower oil) and catalyst contents (FIG. 1A), storage temperature (FIG. 1B, T=4-22° C.), and relative humidity (FIG. 1C, RH 0-76%) on enzyme catalysed production and release of hexanal in CNF supported GGM cryogels. L=lipase, LOX=lipoxygenase.

FIG. 2 illustrates the effect of photosensitizer and storage conditions on the light induced production and release of hexanal in 45 wt-% sunflower oil containing CNF supported GGM cryogels at RH 0% and 76%. FIG. 2A) 5 ppm methylene blue at 22° C.; FIG. 2B) 5 ppm methylene blue at 10° C.; FIG. 2C) 10 ppm riboflavin at 22° C.; FIG. 2D) 50 ppm riboflavin at 22° C.; FIG. 2E) 2700 ppm β-carotene at 22° C.; and FIG. 2F) 15 ppm chlorophyll at 22° C. Tween 20 was used as emulsifier in addition to GGM.

FIG. 3 illustrates the production and release of hexanal, hexanoic acid and other aldehydes from the 25 wt-% sunflower oil and 15 ppm chlorophyll containing CNF-based films under constant light from day 0 to day 40. Films were stored at room temperature and RH 54%.

FIG. 4 illustrates the production and release of hexanal from the 25 wt-% sunflower oil and 15 ppm chlorophyll containing CNF-based films after 1 h, 2 h and 24 h light exposure. Films were stored in dark at RH 54% and room temperature for 25 days after the light exposure.

FIG. 5 illustrates the production and release of hexanal from the 25 wt-% sunflower oil and 15 ppm chlorophyll containing CNF-based films under continuous light exposure and light sequence with light exposure during days 0-3, 6-9 and 12-15 (films were kept in dark during days 3-6 and 9-12). Films were stored at room temperature and RH 54%.

FIG. 6 illustrates the formation of hexanal from the 25 wt-% sunflower oil and 15 ppm, 50 ppm or 100 ppm chlorophyll containing CNF-based films under continuous light exposure at room temperature and RH 54%.

FIG. 7 shows effect of hexanal treatment on formation of mould in blueberries at 22° C. and RH 54%, after storage of 5 days. Left: stored with hexanal-releasing cryogels. Right: stored with cryogels not releasing hexanal.

FIG. 8 shows changes in collapse force of cherry tomatoes after hexanal treatment for four weeks at 22° C. and RH 54%. Tomatoes were stored with hexanal releasing cryogels and with cryogels not releasing hexanal. The data points represent averages and standard deviations of eight replicate samples.

FIG. 9 shows the color (lightness, yellowness, and redness) of bananas after storage of ten days at 20° C. and RH 55%. Bananas were stored with hexanal releasing films and without any films. The data points represent averages of 4-5 replicate measurements.

### EMBODIMENTS

In the present context, “controlled release” refers to the delivery of the desired substance, in this case volatile oxidation products of lipids, at a controlled rate starting at a desired time point, for an extended period of time. The release rate can be controlled by the choice of the components of the composition, the matrix, and the initiator, by their amounts, and by the surrounding conditions. The released total amount can be controlled also by the time the composition is maintained in the vicinity of the fresh plant based goods.

Within the present context, the term “matrix” refers to any medium, preferably a solid or semi-solid medium, which can comprise a lipid phase incorporated therein. A preferred matrix comprises porous material, a gel, or a film, preferably porous material or a film. Porous material includes for example foams, such as solid and semi-solid foams, aerogels, cryogels, and xerogels. In some preferred embodiments the matrix comprises an aerogel or a cryogel (freeze-dried hydrogel) or a film.

In the present context, the term “initiator” includes substances that can either produce radical species themselves or induce production of radical species, typically upon exposure to light (photosensitizer, photoinitiator). However, within this disclosure an initiator also includes non-latent initiators, such as enzymes. In a typical embodiment, the initiator is an added initiator, i.e. an initiator not inherent to the components of the composition. In one embodiment the initiator comprises an added initiator and an initiator inherent to the components of the composition.

In the present context, the term “photosensitizer” or “photoinitiator” comprises compounds or substances capable of absorbing low-level light energy and transforming it into chemical energy. Photo-oxidation occurs mainly in two ways: via singlet oxygen or via radical intermediated reactions. As non-limiting examples of radical forming photosensitizers, for example riboflavin, chlorophyll, and β-carotene may be mentioned. Singlet oxygen, which reacts directly with double bonds, may be selectively produced for example by methylene blue (λₘₐₓ=600-700 nm).

“Active materials” refer generally to materials, which respond to different stimuli by changing one or several of their properties, for example their shape or appearance, or, as in the present invention, by starting the production and release of the desired substances as a response to the effect of the initiator.

Controlled initiation, i.e. the start of the release of volatile oxidation products of lipids at a desired time point, is typically accomplished by exposing the composition of the invention to light (visible light, UV) when the initiator is a photosensitizer, or by incorporating an enzyme initiator to the composition at a desired time.

As stated above, the composition according to the invention comprises a matrix having a lipid phase incorporated therein, wherein the lipid phase comprises an initiator to enable controlled production and release of oxidation products of lipids, in particular volatile aldehydes, ketones, and acids, from lipids of the lipid phase.

In an embodiment of the invention, oxidation products of lipid comprise volatile aldehydes, ketones, and acids, in particular volatile C6 and C9 aldehydes, ketones, and acids, such as hexanal, hexanoic acid, 3-hexanone, nonanal, and 2-nonanone, in particular hexanal.

In an embodiment, the initiator comprises a photosensitizer or an enzyme or a mixture of enzymes, in particular a lipophilic photosensitizer or a water-soluble photosensitizer. The enzyme comprises preferably a lipoxygenase or a mixture of a lipase and lipoxygenase, which are typically added in the composition at a desired time point.

Suitable photosensitizers include but are not limited to photosensitizers having a spectral sensitivity which includes the wavelength regions of the visible light spectrum, such as wavelengths of 400-500 nm or 650-700 nm, and of ultraviolet rays. Typically the photosensitizer is a lipophilic photosensitizer, such as chlorophyll or β-carotene, or a water-soluble photosensitizer, such as methylene blue or riboflavin. A preferred lipophilic photosensitizer is chlorophyll. A photosensitizer is typically added in the composition during preparation of the composition or subsequent thereto. In an embodiment of the invention, a photosensitizer may be inherent to the components of the composition, typically the lipid phase.

In an embodiment of the invention, the initiator is a lipophilic photosensitizer, which is dissolved and dispersed in the lipid phase preferably in an emulsified lipid phase, before incorporation into the matrix. In a further embodiment, the initiator is a water-soluble photosensitizer, which is dissolved in water, which brings it in contact with the emulsified lipid phase of the matrix.

The amount of a photosensitizer in the composition according to the invention is typically 5-5000 ppm, preferably 5-3000 ppm.

In an embodiment of the invention, the lipid phase incorporated in the matrix of the composition according to the invention comprises unsaturated lipids, preferably polyunsaturated lipids. Typically the lipid phase comprises one or several vegetable oils, such as sunflower oil, corn oil, olive oil, peanut oil, rapeseed oil, cottonseed oil, hempseed oil, soybean oil, or algae derived oils, or it comprises fish oil, optionally in combination with vegetable oil(s). In one embodiment of the invention the lipid phase comprises sunflower oil. Lipid phase may also comprise other esters of unsaturated fatty acids such as phospholipids, and/or free unsaturated fatty acids.

It is notable that the lipids as well as the photosensitizers and enzymes used in the present invention are suitable for direct food contact and may even be edible.

In an embodiment of the invention, the lipid phase is mixed with an emulsifier to obtain an emulsified lipid phase before incorporation into the matrix. Suitable emulsifiying agents include any emulsifying agents known to a person skilled in the art. Examples of emulsifying agents include but are not limited to polysorbates, phospholipids, proteins, polysaccharides, or their derivatives, and nanoparticles. In an embodiment of the invention, hemicellulose enriched extracts, such as galactoglucomannans, in particular spruce galactoglucomannans, can be used.

Emulsification of the lipid phase ensures interaction of water soluble initiators (e.g. enzymes and photosensitizers) with the lipid substrates, facilitates the delivery of lipid in the matrix and increases the surface area of lipids available for oxidation and production of active compounds. Preferably, the emulsifying agent also stabilizes the lipid phase against autoxidation. Particularly, galactoglucomannans are able to inhibit lipid oxidation in emulsions up to months even at accelerated conditions (Lehtonen et al, 2016, Lehtonen et al. 2018). In an embodiment of the invention, wherein galactoglucomannans are included in the matrix, they provide the advantage of inhibiting possible spontaneous oxidation of lipids, thus enabling more controlled initiation and release of volatile oxidation products of lipids.

When the initiator comprises an enzyme or a mixture of enzymes, said enzymes are preferably selected from lipoxygenases and lipases. In an embodiment wherein the lipid phase comprises vegetable oils (i.e. triacylglycerides), a mixture of lipase and lipoxygenase is required. Also emulsification of the lipid phase is preferred.

In a further embodiment of the invention, wherein the lipid phase comprises free fatty acids, lipoxygenase may act as an enzyme initiator. As free fatty acids are dispersible in the matrix, emulsification is not necessarily required.

Solid porous materials, such as aerogels and cryogels, are lightweight materials which have large surface area. High porosity of aerogels and cryogels makes them beneficial materials for the release and delivery of active compounds into the surroundings for example in food packaging or in pharmaceuticals. The low density of said gels is also a desirable feature for packaging materials. Aerogels are often prepared using silica or carbon, but also polysaccharides are suitable for this purpose. In practice, aerogels are prepared from liquid gels by replacing liquid with air, particularly by using supercritical carbon dioxide which requires a solvent exchange step. Cryogels are prepared from liquid gels by lyophilisation, which retains the structure of the gel and leads to high volume cryogels.

In the present invention, polysaccharides, such as cellulose, hemicelluloses and starch, which are sustainable bio-based raw materials, suitable for direct food contact and may even be edible, are preferred raw materials of aerogels and cryogels.

Polysaccharides form aerogels and cryogels that have strong and flexible structures enabling use in wide range of applications. In addition, raw materials for these gels can be recovered from side streams of for example paper and pulp industry.

In an embodiment of the invention, the matrix is thus an aerogel, cryogel, or a film, in particular a polysaccharide-based aerogel, cryogel, or a film. Typically the matrix is an aerogel, cryogel, or a film based on cellulose, hemicellulose, and/or starch.

In an embodiment, the matrix is an aerogel or cryogel based on hemicelluloses, preferably an aerogel or cryogel based on softwood hemicelluloses, such as softwood galactoglucomannans (GGM), or hardwood xylans, preferably further comprising nanofibrillated cellulose (also called microfibrillated cellulose).

In a further embodiment, the matrix is an aerogel or cryogel based on nanofibrillated cellulose, preferably further comprising softwood hemicelluloses, typically GGM.

In another embodiment of the invention, the matrix or the composition is in the form of a film based on nanofibrillated cellulose, preferably further comprising softwood hemicelluloses, typically GGM.

In some embodiments, the matrix may also contain a cross-linker, such as ammonium zirconium carbonate, tannic acid, or citric acid.

In an embodiment, aerogels containing up to 50 wt.-% of lipid substrate for hexanal production can be prepared by freeze drying. In addition, catalysts or initiators for the lipid oxidation can be incorporated during or after the production.

In an embodiment, the matrix in the composition of the invention is an aerogel or cryogel comprising 1-60% lipids, 5-50% hemicelluloses, 5-50% nanofibrillated cellulose, based on the dry weight of the aerogel or cryogel, and at least one initiator.

The composition or the matrix may be provided in any appropriate form, for example in the form of a film, membrane, mat, sheet, plate, patch, layer, coating, lining, pad, sachet, label, a package or part of a package, or as foam or powder.

In embodiments of the invention, the production and release of volatile oxidation products of lipids can be controlled by the choice of the substrate and catalyst or initiator and their contents in the composition of the invention. In some embodiments, low lipid content would be desirable for retaining the physical properties of packaging materials. However, by the reduction of the lipids, the production of volatile oxidation products may be exhausted leading to less efficient shelf life enhancement. High catalyst content would increase the rate of formation, but at the same time it would also increase the formation of side products, such as oxidation products of hexanal. Thus, by maintaining as high substrate content as feasible and as low initiator or catalyst content as possible, a steady and long-term production and release of hexanal in aerogels is enabled.

In an embodiment, the present invention provides also an active package or active material for storage of fresh plant products, particularly fresh food products, such as fruit, berries and vegetables, or cut flowers, the package or material comprising the composition according to the invention.

The package or material preferably comprises the composition in an amount sufficient to produce a minimum of 1-20 μmol/l hexanal, typically for at least 10 days, preferably for at least 14 days, and more preferably at least three weeks. Typically the package or material comprises the composition of the invention in an amount of at least 1 g per 1 litre package or per 1 litre of storage atmosphere, preferably at least 0.5 g, and more preferably at least 0.1 g composition per 1 litre package or per 1 litre of storage atmosphere.

In a further embodiment, the package comprises the composition in an amount sufficient to produce at least 300 nmol hexanal per 70 grams of the fresh plant product.

In a preferred embodiment, the package is at least partly transparent or translucent. The whole package or only a certain area of the package, such as the upper side or upper surface of the package, may be transparent. Transparency enables the photoinitiator to be exposed to visible light, thus starting the creation of reactive species.

When the composition of the invention is incorporated in the storage space in the vicinity of the fresh plant based goods, a sufficient amount of the composition is for example from 0.5 g to 10 g of the composition per 1 kg of the fresh plant based goods, typically approximately 1 g of the composition/kg fresh plant based goods.

In an embodiment, the present invention also provides a method for continuous in situ production and controlled release of volatile aldehydes, ketones, and acids, in particular volatile C6 and C9 aldehydes, ketones, and acids, preferably hexanal, in packages or in the vicinity of fresh plant based goods, for a storage period of at least 10 days, wherein the method comprises providing a composition according to the invention and incorporating said composition in the package, in the packaging material, or in the storage space in the vicinity of the fresh plant based goods.

In an embodiment, the initiator incorporated in the lipid phase in the matrix of the composition is a photosensitizer. The package or the composition is exposed to visible light or to ultraviolet rays during the storage of the goods in the package, for example continuously, periodically, or only at the beginning of the storage. The amount of exposure to visible light can be used to control the rate of release of the desired substances. A short exposure, for example below or about 1 h, to visible light at the beginning of storage leads to lower and slower release of volatile compounds from the lipid phase than continuous exposure to light during storage.

In another embodiment, the composition comprises an enzyme initiator, which is included in the matrix or is added therein at a desired time for initiating oxidation and release of volatile aldehydes, ketones, and acids, in particular hexanal. When the enzymes are included in the composition at a desired time after preparation of the composition, this may be done for example by injecting, dipping, or spraying the enzymes in the composition.

High levels of hexanal per gram of the compositions of the invention could be produced and maintained up to three weeks at room temperature under relative humidities of 0-76%. The achieved hexanal levels were high enough in all systems to extend shelf life of fruits, vegetables, berries, and cut flowers. Mould growth was reduced significantly in blueberries (70 g) stored under 200-300 nmol of hexanal. Continuous exposure to hexanal at as low concentration as 0.54 nmol/L has been shown to lead to a 50% reduction in the fungal growth (Andersen et al. 1994). In the present invention, continuous production of this content would be reached with much less than 1 mg of aerogel. On the other hand, other authors have proposed that for fungicidial effects up to 9-20 μmol/L hexanal is needed (Almenar et al. 2007). These concentrations were shown to reduce fungal growth up to 57%. To produce such levels, 0.07-0.7 g of enzyme containing aerogel or cryogel would be needed for a 1-2 litre package or for storage atmosphere of 1-2 L. For light induced production, 0.2-2 grams would be sufficient.

The compositions of the invention thus function as delivery systems for substrates and catalysts for in situ production and release of volatile oxidation products of lipids in fresh plant packaging or storage. The matrix used in the composition did not inhibit the contact of lipids and photosensitizers to light nor did it inhibit lipid oxidation or release of formed volatile aldehydes into the atmosphere. Hexanal was produced at sufficient levels at least for three weeks to preserve fresh plants against mould growth and against senescence.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

### EXPERIMENTAL

Sunflower oil (SFO) was used as a substrate for hexanal production. Galactoglucomannan (GGM) was obtained from Norway spruce by pressured hot-water extraction and ethanol precipitation (Kilpeläinen et al. 2014). For cryogels used in hexanal release tests during storage, 2.7% suspension of anionic cellulose nanofibrils (CNF) (fiber width 4-10 nm, zeta potential −25 mV) from birch pulp was used. For cryogels used in shelf life studies for tomatoes and blueberries and for film studies, 1% CNF suspension from softwood pulp was used. The banana storage tests were conducted using 1% anionic CNF from softwood pulp (800-900 μmol carboxylic acid groups per gram of CNF). Hexanal was used for preparation of standard curve for quantification. Lipase (L) from Candida rugosa (Type VII, ≥700 unit/mg solid) and lipoxygenase (LOX) from soybean (Glycine max; Type I-B, lyophilized powder, ≥50,000 units/mg solid) were used for the enzyme catalysed oxidation of SFO. Riboflavin, β-carotene, and chlorophyll (extracted from spinach or Chlorella by accelerated solvent extraction using acetone or ethanol) were used as catalysts for the light induced oxidation of SFO.

Preparation of Cryogels

For active production and release of hexanal, hydrogels were prepared using 2 wt.-% of GGM and CNF (70:30, w/w) in water and ammonium zirconium carbonate (2.5-12.5 wt.-% from polysaccharides) as cross-linker. High 18:2/18:3 sunflower oil (SFO; 60 wt.-%) was emulsified with water using GGM (12 wt.-%) as a stabilizer. Alternatively, Tween20 (12 wt. %) was used as an emulsifier. For enzyme catalysed oxidation, lipase and lipoxygenase were added to the aqueous phase at contents 0-1200 U/g lipids and 0-12 000 U/g lipids, respectively, prior to emulsification. For light induced oxidation, 0-50 ppm of either methylene blue or riboflavin were added to the aqueous phase prior to emulsification. β-carotene and chlorophyll were dissolved in acetone and 1-5 ml of this solution was dispersed into SFO to result levels of 2700 ppm and 15 ppm, respectively. To ensure thorough dissolvent of photosensitizers and evaporation of acetone, mixing was continued overnight. 1.5 wt.-% or 3.5 wt.-% of the emulsion was added to hydrogel and mixed properly. After the mixing, the hydrogel was divided into clear or amber glass vials (75.5×22.5 mm) each containing 2 grams. The sample vials were left to settle overnight at room temperature. The hydrogels were freezed at −20° C. and further at −70° C. after which the hydrogel was lyophilized into cryogels at 1 mbar for 48 hours. The open sample vials were placed at different relative humidities and temperatures for storage.

It is known that cryogels consisting of 1 wt.-% of GGM and 1 wt.-% of CNF can be formed by crosslinking the polysaccharides with AZC and lyophilizing the formed hydrogel (Alakalhunmaa et al. 2016). For the release of hexanal from cryogels, lipids had to be incorporated to the polysaccharide hydrogel matrix prior drying to cryogels. Additional ingredients could possibly affect the formation of polysaccharide network, but more importantly, the release of hexanal could be influenced by the cryogel matrix. Therefore, cryogels containing SFO and added hexanal were studied prior to in situ production and release of hexanal. Cryogels consisting of 30-45 wt.-% oil, 28-35 wt.-% GGM and 28-35 wt.-% CNF maintained their structure during the drying process. According to the preliminary studies, this high oil content did not affect the volume nor the compression strength of cryogels. Surprisingly, in situ production and prolonged release of hexanal could be achieved in cryogels by introducing vegetable oil and various catalysts into hydrogel prior their drying into cryogels. Initiation of the reaction was assisted either by enzymes or light.

Determination of Volatile Compounds by HS-SPME-GC-MS

The formation of hexanal and other volatile products in cryogels was monitored by head space solid-phase microextraction combined with gas chromatography-mass spectrometry (HS-SPME-GC-MS) according to previously described method (Lehtonen et al, 2016). At each sampling time, three replicate cryogel containing vials were withdrawn and sealed for the analysis. The sample vials were agitated at 40° C. and 250 rpm for 10 min prior to extraction with a DVB/CAR/PDMS fiber (10 mm, 50/30 μm film thickness) at 40° C. and 250 rpm for 30 min using an HS-SPME injector. The extracted compounds were released in a splitless injector at 250° C. for 10 min and run with GC-MS. Compounds were separated and the volatile compounds were identified based on their mass spectra and by comparing the retention times and mass spectra with those of known standards. Contents of hexanal were estimated based on external standard curve. Hexanal was spiked into sunflower oil at a range of 0.5-55000 ng/g and 0.5 grams of spiked oil was placed in headspace vials corresponding to a standard curve at a range of 0.25-27500 ng hexanal. The contents of volatile products were reported as peak areas. Averages and standard deviations of the three replicate samples were reported.

Enzyme Catalysed Production of Hexanal in Cryogels

For enzyme catalysed production of hexanal, cryogels containing 45% oil, 120 U lipase/g oil and 1250 U LOX/g oil were placed into desiccator cabinets having adjusted relative humidities (RH) of 0% by dry phosphorous pentoxide, 54% by saturated calcium chloride solution, and 76% by saturated sodium chloride solution. The cabinets were placed at controlled temperatures of 10° C. and 22° C. In addition, sealed vials representing RH of 0-10% were placed at 4° C. Samples were kept protected from light in amber vials.

For each sample type, three replicate vials were withdrawn every three days throughout 3-week period for the headspace analysis of hexanal and other volatile compounds by HS-SPME-GC-MS.

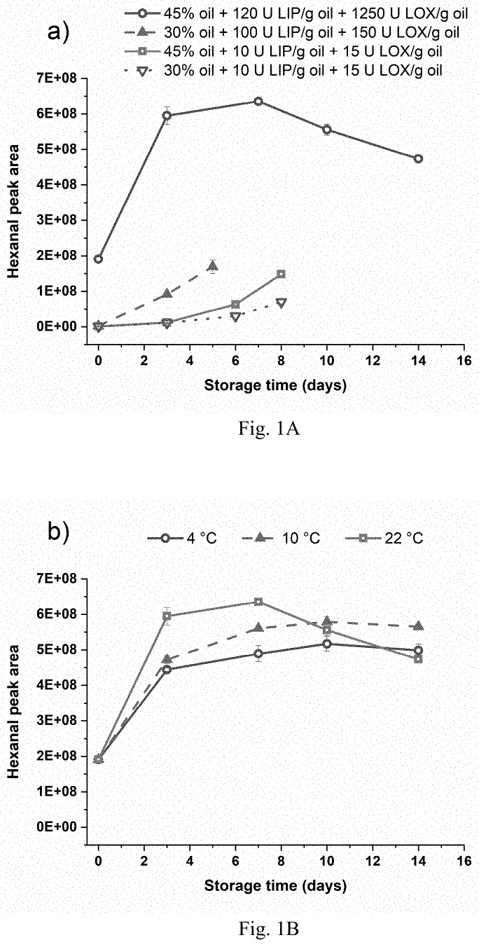

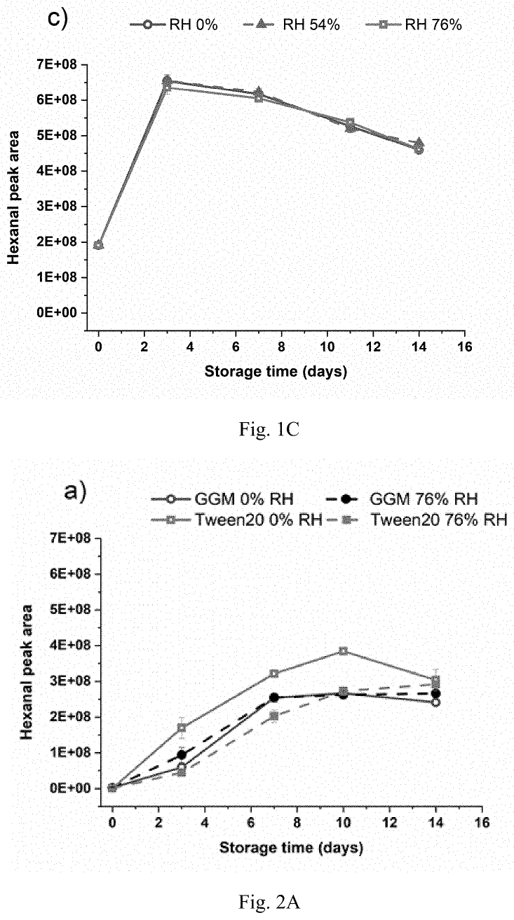

For enzyme catalysed lipid oxidation and hexanal production, the amount of required substrate and catalysts were investigated. Production of hydroperoxides and further hexanal was not achieved if only LOX was incorporated to the emulsion, but also small amount of lipase was needed. Production of hexanal was apparent already during hydrogel preparation and the production continued throughout cryogel preparation. As high levels as 7 μmol hexanal/g cryogel were measured immediately after freeze-drying the hydrogels into cryogels (FIG. 1A). The amount of hexanal increased up to 17-23 μmol/g during the first three days. The levels were maintained throughout two weeks of storage. The reaction rates and thus the levels of hexanal were highly dependent on the substrate and catalyst contents. Hexanal constituted 15-72% of the formed volatile products. Hexanal remained the predominant compound for 3-8 days after which considerable amount of hexanoic acid, a reaction product of hexanal, was measured.

By altering the amount of substrate (i.e., SFO) and catalysts (i.e., lipase and LOX), the production of hexanal could be controlled. With low amount of substrate and catalyst (30%+15 U LOX/g oil) the level of released hexanal was approximately 1.2 mol/g after 8 days. Changes in the contents of SFO and enzymes affected similarly the production of hexanal: Doubled oil content augmented the rate of formation 2-fold. Similarly, when the enzyme content was increased 10-times, the formation rate was augmented 9-fold. At low activity (i.e., 15 units/g oil), hexanal was the main volatile product (19-72% of the total) and only low levels of other products were detected (0-19% of the total). When the activity of LOX was increased tenfold, the level of hexanal was increased but at the same time its proportion decreased 4-fold. At the same time, other products were detected already after three days. When the activity of LOX was increased additional 10-times, the proportion of hexanoic acid increased 10-fold. At the highest studied LOX level (i.e., 1250 U/g oil), the production of hexanal was in a desirable range of 17-23 μmol/g of cryogel at least for two weeks. Yet, the proportion of other individual volatile lipid oxidation products remained low, that is 0-4% of the total products.

The production and release of hexanal was feasible at the studied temperature range 4-22 (FIG. 1B). The formation of hexanal was increased by increased temperature: After three days of storage, the content of hexanal was 26-32% greater when cryogels were stored at 22° C. compared to those stored at 10° C. or at 4° C. In addition, side reactions were favoured at elevated temperatures. Decomposition of hexanal was occurring rapidly in cryogels stored at 22° C., which was seen as a significant decrease in its content. In addition, after one week of storage, the proportion of hexanoic acid became greater than that of hexanal. The change was more evident in the cryogels stored at 22° C. than in those stored at 10° C. or at 4° C.

Production and release of hexanal was not affected by the relative humidity at storage conditions (FIG. 1C). The levels of released hexanal were similar at RH 0-10%, 54% and 76% through out two weeks of storage. Moreover, the proportion of hexanal remained similar at each of the studied RH. Decomposition of hexanal occurred in a similar manner at each of the studied RH.

Light Induced Production of Hexanal in Cryogels

For light induced oxidation, cryogels containing 45% oil and 0-50 ppm of photosensitizer were placed into desiccator cabinets having adjusted RH of 0% by dry phosphorous pentoxide and RH of 76% by saturated sodium chloride solution. The cabinets were placed at controlled temperatures of 10° C. and 22° C. Samples were kept in clear vials and they were exposed to continuous light in a climate chamber for 0-3 weeks.

For each sample type, three replicate vials were withdrawn every three days throughout 3-week period for the headspace analysis of hexanal and other volatile compounds by HS-SPME-GC-MS.

To store hexanal producing cryogels before their actual use in packaging, the initiation of hexanal production should be feasible after the cryogel preparation. For this purpose, either autoxidation or photo-oxidation of lipids could be utilized. Autoxidation, being a free radical chain reaction, produces a wide variety of reaction products and is highly dependent on the surrounding compounds varying from matrix to another. Thus, the specific and controlled production is not possible. In our preliminary studies, the production of hexanal (and other volatile products) could be launched by short term heat treatment, but the amount and proportion remained below 12 μmol/g cryogel and 14%, respectively. Therefore, photo-oxidation was the preferred method compared to autoxidation. The oxidation mechanisms were altered by trialling various photosensitizers and by altering their contents.

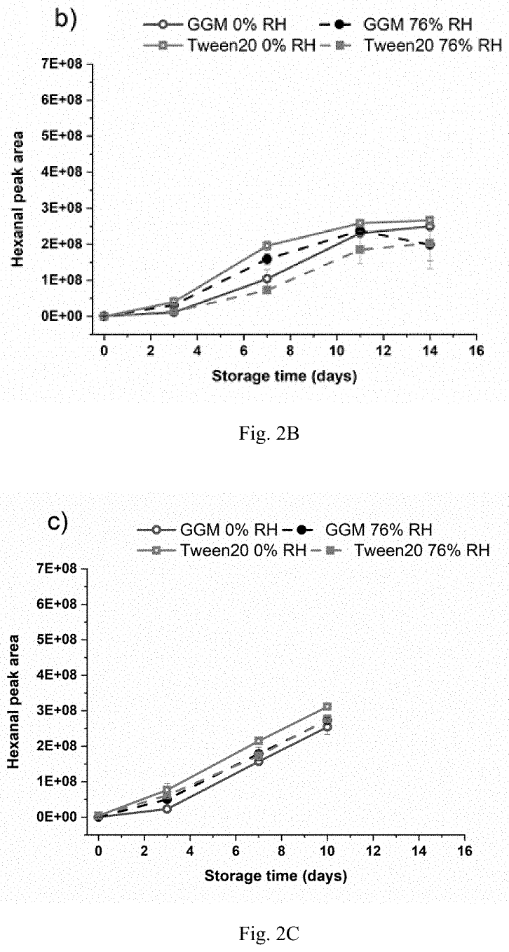

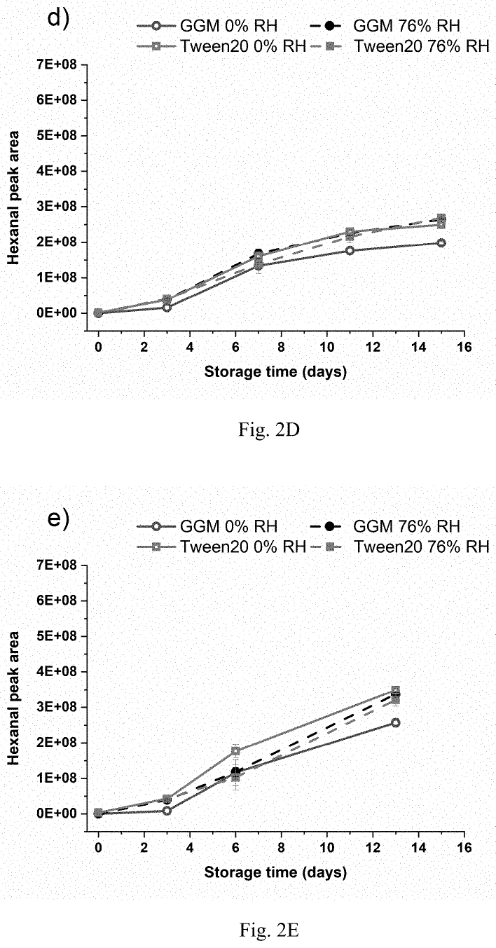

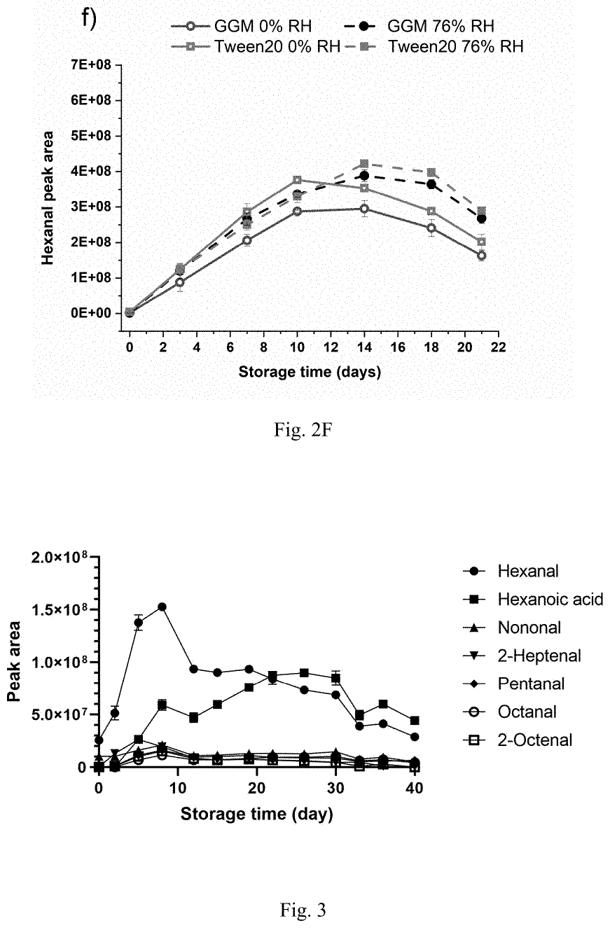

In light induced oxidation, the progress of lipid oxidation remained slow with low amounts of catalysts (5-50 ppm) (FIG. 2). The slower the progress, the higher the proportion of hexanal: 30-71% of formed volatile products throughout 2 weeks of storage. Correspondingly the proportion of other individual volatile products remained below 23%.

Lipid oxidation via singlet oxygen using methylene blue as photosensitizer produced approximately 7-10 μmol hexanal/g (FIGS. 2A, 2B), that is, half of the amount achieved by enzyme catalysed reaction. The level was maintained throughout the 2-3-week storage test. Equal contents were obtained in GGM and Tween20 stabilized systems. At 22° C., the reaction rates were greater than at 10° C. 7 days of storage at 22° C. resulted in the same maximum levels of approximately 9 mol/g as 11 days at 10° C. RH did not significantly affect the reached maximum levels of released hexanal, but for GGM stabilized system, the reaction rates were greater at RH 76% than at RH 0%. While reaction rates were greater, also the reaction of hexanal into hexanoic acid and production of other volatile products was increased. Interestingly, the opposite behaviour was observed in cryogels incorporated with Tween20 stabilized emulsion: Reaction rates were greater at RH 0% than at RH 76%.

When lipid oxidation was initiated by radical forming photosensitizer, riboflavin, hexanal levels of 7-10 mol/g were released after 11-18 days of storage under continuous light (FIGS. 2C, 2D). At RH 0%, hexanal remained as the main volatile product for 7 days (34-58%) after which the proportion of hexanoic acid became greater (35-43%). At RH 76%, on the other hand, hexanal remained the main volatile product (36-49%) throughout the 18-day experiment. Thus, reaction rates in GGM containing systems were significantly greater at RH 0% than at RH 76%. This was especially evident in high proportion of hexanoic acid. Formation of hexanal and hexanoic acid was similar in samples containing 10 ppm of riboflavin as in samples containing 50 ppm of riboflavin. In addition, stabilizer did not influence the production, but similar contents were measured in systems containing GGM and Tween20.

Also, lipid soluble sensitizers were investigated to produce hexanal. They were dissolved into the oil phase before emulsification. Excess β-carotene, that is 2700 ppm, was able to initiate lipid oxidation and thus hexanal formation (FIG. 2E). Production rates were relatively slow compared to other studied systems, but the final hexanal levels were higher. Levels of approximately 3 mol/g were reached in one week and further contents of 10-14 mol/g were reached in two weeks. After reaching this level, it was maintained at least for additional week. While the content of hexanal was still increasing, hexanal was the main constituent (61-68%) of the formed products. After two weeks, the proportion of hexanal was 20-30% at RH 0% and 40-45% at RH 76%. Correspondingly, the proportion of hexanoic acid increased being 30-36% at RH 0% and 10-16% at RH 76%. The obtained results were similar both in GGM and Tween20 stabilized lipid systems.

Chlorophyll is a lipid soluble photosensitizer which may act both via singlet oxygen and via radical reactions. This could potentially ensure hexanal production at wide temperature range and accelerate the formation of hexanal compared to purely singlet oxygen pathway. At the initial stage, hexanal production was similar as in cryogels containing methylene blue. As the storage time was prolonged, contents of 11-15 μmol/g were reached (FIG. 2F). Both in GGM and in Tween20 stabilized systems, the rate of lipid oxidation was greater at RH 0% than at RH 76%. Thus, lower levels of hexanal were detected at RH 0% (11 μmol/g) than at RH 76% (15 μmol/g) and the levels decreased earlier due to the decomposition of hexanal into hexanoic acid. At RH 0%, the proportion of hexanal was 24-28% during the first week of storage. After three weeks, the proportion reduced to 13%. After 10 days of storage, the content of hexanal levelled and at the same time proportion of hexanoic acid (35%) became larger than that of hexanal. While, at RH 76%, the proportion of hexanal was 24-30% for the whole 3-week storage period. The proportion of hexanoic acid remained below 20% throughout 3 weeks.

Control samples, that were not exposed to light treatment but were covered with aluminium foil and otherwise maintained at similar conditions, did not release any hexanal.

For each sample type, three replicate vials were withdrawn every three days throughout 3-week period for the headspace analysis of hexanal and other volatile compounds by HS-SPME-GC-MS.

In the above disclosed experiments, levels of 7-23 μmol hexanal per gram of cryogel could be produced and maintained up to three weeks at room temperature under relative humidities of 0-76%. The production was most efficient in the enzyme catalysed system while being lowest during singlet oxygen photoxidation. The achieved hexanal levels were great enough in all systems to extend shelf life of fruits, vegetables and berries.

According to present results, greater contents of hexanal than 300 nmol/70 grams of product are likely needed to slow down tissue softening due to ripening and senescence. According to earlier studies, 150 μmol of hexanal applied as batch-wise treatment per 100 g sliced apples extended the shelf life both at 4° C. and 15° C. (Lanciotti et al., 1999). Multiple treatments of blueberries with hexanal at concentrations as high as 37 mmol/kg blueberries for 24 hours inhibited decay up to 70% (Song et al. 2010).

In the light induced lipid oxidation, photoxidation, initiation of the hexanal production could be easily controlled while in the above disclosed enzyme catalysed system the production of hexanal started already during the manufacture of the material. However, the enzyme(s) can be included in the composition at a desired time by a suitable method, for example by injecting, dipping or spraying the enzyme in the composition. In the enzyme catalysed system, the levels of produced hexanal and side reactions could be controlled. Using lipase and lipoxygenase alongside, formation of hydroperoxides and further production of hexanal was achieved, thus leading to high proportion of hexanal and low production of other volatile oxidation products.

Preparation of Films

To induce lipid oxidation, 15 ppm chlorophyll as photosensitizer dissolved in acetone was dispersed into sunflower oil to reach the required concentration and stirred overnight. An emulsion was prepared by carefully mixing 12 w/w-% GGM, 28 w/w-% MilliQ water and 60 w/w-% sunflower oil of around 20 ml with a mechanical mixer at 11,000 rpm for 5 min. The emulsion, CNF and sorbitol, added as plasticizer (sorbitol:CNF=1:4), were mixed with Ultra-Turrax at 11,000 rpm for 5 min to ensure complete homogenization. The mixture contained CNF as the matrix responsible for the mechanical integrity of films. 45 g of the mixture was carefully poured into a polystyrene petri dish, diameter 12 cm, or 60 g on a dish with diameter 14 cm, and dried into film in a climate chamber at 40° C./50% RH or 23° C./50% RH protected from light. Final dry films contained 25 wt-% oil, 5 wt-% GGM, 14 wt-% sorbitol and 56 wt-% CNF.

Release of Hexanal from Films

The films were cut into small pieces after drying into film. Each transparent glass vial (75.5*22.5 mm) was filled with 200 mg of the films (containing 50 mg sunflower oil). The transparent glass vials were placed into desiccator cabinets and the RH was controlled at 54% by saturated calcium nitrate with the cap open. The samples were exposed under continuous light in a climate chamber for 40 days. After every 3 days, three replicate vials were withdrawn and sealed with cap immediately for either HS-SPME-GC-MS or SHS-GC-FID.

Determination of Hexanal by SHS-GC-FID

The formation of hexanal in films was monitored by static head space gas chromatography coupled to flame ionization detector (SHS-GC-FID) according to previously described method (Kylli et al, 2011). At each sampling time, three replicate film containing vials were withdrawn and sealed for the analysis. The sample vials were agitated at 80° C. for 18 min prior to run with GC-FID. Compounds were separated and hexanal was identified by comparing its retention time to that of a known standard. The content of hexanal was reported as peak areas. Averages and standard deviations of the three replicate samples were reported.

Influence of Storage Time on Hexanal Formation and Release from Films

Hexanal was the main volatile product formed and released from light exposed CNF films throughout three weeks storage (FIG. 3). The greatest hexanal release was reached after 6 days. After three weeks the release decreased but continued for the whole 40 days measuring period. Hexanal was further reacting into hexanoic acid, whose content increased continuously for four weeks. Some side products such as nonanal, 2-heptenal, pentanal, octanal and 2-octenal were also formed but in relatively low quantity.

The Influence of Initiation Time on Hexanal Release from Films

Light induced oxidation may continue as chain reaction meaning that the oxidation continues after certain time of light exposure. Various light exposure times were tested. Films were exposed under light for 1 h, 2 h and 24 h. After the limited light exposure, the films were cut into small pieces and transferred into sealed amber glass vial (75.5*22.5 mm) (200 mg film in each vial) and further stored in dark. The hexanal release was measured at day 2, 6, 9, 12 and 25 in replicates with SHS-GC-FID.

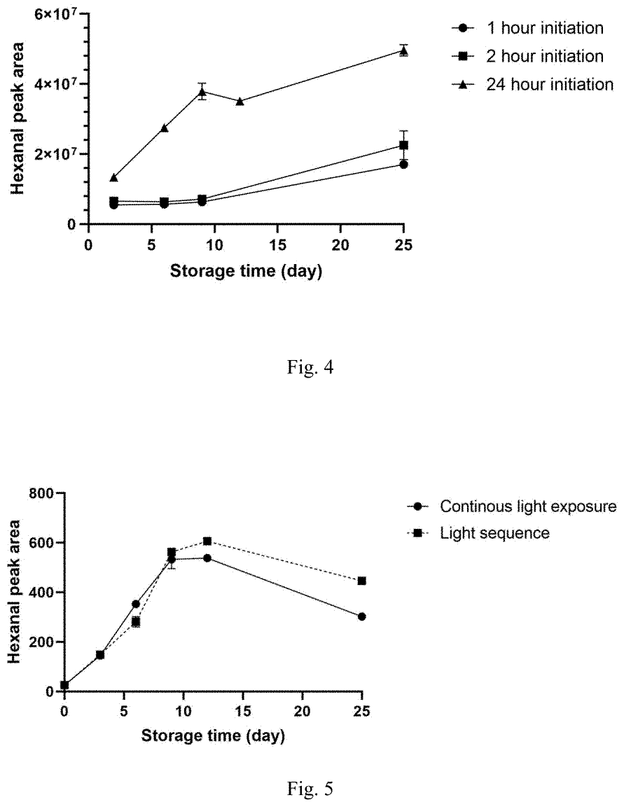

As can be seen in FIG. 4, longer light exposure time resulted in higher hexanal release. Thus amount of hexanal released can be controlled by varying light exposure times. The reaction does not stop after light is turned off, and thus continues after initiation also in dark.

The Influence of Light Sequence on Hexanal Release from Films

The hexanal release of films under continuous exposure was compared with the films that were exposed under light during day 0-3, 6-9, 12-25. The sample with light sequence treatment was kept under dark during days 3-6 and 9-12. The hexanal release was determined in replicates every 3 days between 0-12 and at day 25 by SHS-GC-FID.

As can be seen in FIG. 5, hexanal release was similar up to 10 days regardless of the light exposure. Maximum level of released hexanal was measured after 10 days. With greater light exposure, oxidation reactions were accelerated leading to lower levels of measurable hexanal levels and instead greater decomposition into other products. Thus the levels of produced and released hexanal may be controlled by light sequences.

The Influence of Chlorophyll Concentration on Hexanal Release from Films

The films were incorporated with 15 ppm, 50 ppm and 100 ppm chlorophyll respectively. The hexanal release was determined in replicates every 3 days between 0-12 and at day 25, 40 by SHS-GC-FID.

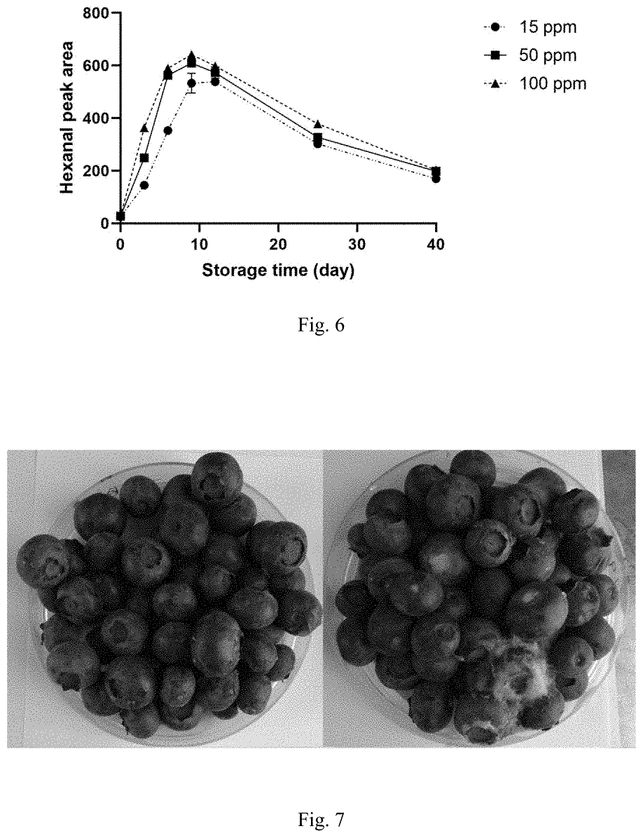

As can be seen in FIG. 6, the higher amount of photosensitizer resulted in the greatest release of hexanal.

To conclude, the different photosensitizers and reaction routes result in varying amounts of hexanal, as shown by the cryogel experiments. Hexanal production via singlet oxygen route using methylene blue was found to be rather slow. When oxidation of lipids was initiated by radical forming sensitizer, riboflavin, the formation rate of hexanal was greater than by singlet oxygen forming methylene blue.

However, when chlorophyll was applied to initiate hexanal production, greater contents of hexanal could be obtained and the reaction of hexanal into hexanoic acid could be controlled. Chlorophyll (λₘₐₓ=400-500 nm and 650-700 nm) has the ability to act via both of the above described routes enabling production of hydroperoxides even at low temperatures and concomitantly the production of radicals to induce the breakdown of hydroperoxides into hexanal.

Interestingly, also β-carotene at excess concentrations was able to initiate lipid oxidation in cryogels. This may be because β-carotene itself is able form of reactive radical species (Schaich et al., 2013).

Shelf Life of Fruit, Berries and Vegetables

The effect of hexanal producing and releasing matrices on shelf life of berries, vegetables, and fruit, were investigated with blueberries (non-climacteric), cherry tomatoes (climacteric, i.e., ethylene producing), and bananas (climacteric). 70 grams of blueberries or cherry tomatoes were packed by placing them on top of 1 gram of cryogel (ø 92 mm) and covering with low-density polyethylene plastic bags. Plastic bags were sealed with heat and for every bag four small holes were made to enable respiration. For each sample type, 2 replicate packages were prepared. The cryogel used in the shelf life experiments was reinforced with CNF and hexanal production was catalysed by 15 ppm chlorophyll. Also, cryogels without hexanal production (i.e., without addition of SFO and chlorophyll) were prepared for comparison. Packages were placed into separate desiccator cabinets having adjusted relative humidity of 54% by saturated calcium chloride solution. The cabinets were stored under continuous lighting and at controlled temperatures of 22° C. in a climate chamber for four weeks. Changes occurring in the packed blueberries and cherry tomatoes were visually inspected. In addition, collapse force was determined from cherry tomatoes. Production and release of hexanal from cryogels were monitored during the storage. Part of the original hydrogel was dried into cryogels in vials which were stored at the same conditions as the packages. Released hexanal and other volatile products were determined by HS-SPME-GC-MS. For the banana storage test, 12 bananas were placed on trays with CNF films (one banana on one film, without plastic bags or wrapping), containing 15 ppm chlorophyll, inside desiccator cabinets with controlled relative humidity of 55%, temperature of 20° C., and constant light. For comparison, control bananas were stored in similar conditions, but without any films.

Mould growth was reduced significantly in blueberries (70 g) stored under 235-300 nmol of hexanal for five days, as can be seen in FIG. 7

Determination of Collapse Force by Compression Testing

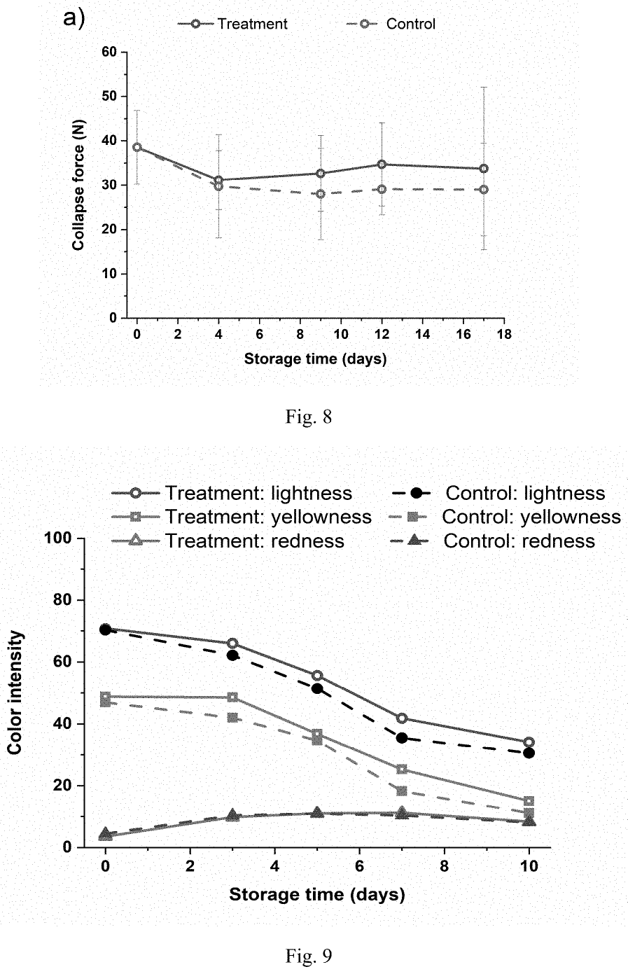

Collapse force was determined in order to estimate the effect of hexanal on senescence and cell wall eruption in cherry tomatoes. Texture Analyser TA-XT2i (Stable Micro Systems, Godalming, UK) was used to perform the compression testing. Compression test consisted of two subsequent cycle compressions that as a result yield stress-strain curves. Samples were collected at five different time points (after 0, 4, 9, 12 and 17 days of storage). For every time point 8 replicate tomatoes were measured. For the measurement each tomato was placed identically to the platform of the texture analyser. Because of the slight differences in tomato height the compression was set to be 60% of the tomatoes initial height. Compression tests pre-test speed was set to 1 mm/sec and test speed and post-test speed was set to 2 mm/sec. Loaded cell was 30 kg and applied trigger force 10 g. Diameter of the aluminium compression platen was 100 mm. Collapse force was calculated from gained stress-strain curves. Cherry tomatoes stored with hexanal releasing cryogel maintained their firmness better than control samples (FIG. 8).

Shelf-Life of Bananas

The banana skin color was measured during storage of ten days. 12 bananas were measured at 4 points each. A Konica Minolta spectrophotometer CM-2600D was used to measure the values L (lightness), a (redness), and b (yellowness). The results are shown in FIG. 9.

The banana color remained more light and yellow during a 10 day storage when stored with hexanal-releasing films, in comparison with bananas stored without the films (FIG. 9). No difference was observed between the banana side facing the film or the side facing air.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

The embodiments of the present invention find industrial application in the field of active packaging and storage, particularly in active packaging of fresh plant based products which are transported long distances or stored for long times. The active material or composition of the invention may be incorporated in the packaging material, or inserted in the packages or in the storage space in the vicinity of various fresh plant products to extend shelf life. Typically the fresh plant based goods include fresh fruits, berries, vegetables, and cut flowers.

### ACRONYMS LIST

AZC ammonium zirconium carbonate
CNF cellulose nanofibrils
GC-FID gas chromatography-flame ionization detector
GGM galactoglucomannan
LIP lipase
LOX lipoxygenase
RH relative humidity
SFO sunflower oil
HS-SPME-GC-MS Head space solid-phase microextraction combined with gas chromatography-mass spectrometry

### CITATION LIST

### Patent Literature

EP 0598920 A1
EP 14697361 A1
U.S. Pat. No. 6,514,914
WO 2017055424 A1

### Non Patent Literature

Alakalhunmaa S., Parikka, K., Penttilä, P., Cuberes, M. T., Willför, S., Salmén, L. & Mikkonen, K. S. (2016). Softwood-based sponge gels. Cellulose, 23, 3221-3238.
Almenar, E., Auras, R., Rubino, M., & Harte, B. (2007). A new technique to prevent the main post harvest diseases in berries during storage: Inclusion complexes O-cyclodextrin-hexanal. International Journal of Food Microbiology, 118, 164-172.
Andersen, R. A., Hamilton-Kemp, T. R., Hildebrand, D. F., McCracken Jr., C. T., Collins, R. W., & Fleming, P. D. (1994). Structure-antifungal activity relationships among volatile C6 and C9 aliphatic aldehydes, ketones, and alcohols. Journal of Agricultural and Food Chemistry, 42, 1563-1568.
Jash, A. & Lim, L-T. (2018). Triggered release of hexanal from an imidazolidine precursor encapsulated in poly(lactic acid) and ethylcellulose carriers. J Mater Sci, 53, 2221-2235.
Jash, A., Paliyath, G. & Lim, L-T. (2018). Activated release of bioactive aldehydes from their precursors embedded in electrospun poly(lactic acid) nonwovens. RSC Adv, 8, 19930-19938.
Kilpeläinen, P., Hautala, S., Byman, O., Tanner, J., Korpinen, R., Lillandt, M., Pranovich, A., Kitunen, V., Willfor, S., & Ilvesniemi, H. (2014). Pressurized hot water flow-through extraction system scale up from the laboratory to the pilot scale. Green Chemistry, 12, 3186-3194.
Kylli, P., Nohynek, L., Puupponen-Pimia, R., Westerlund-Wikstrom, B., Leppänen, T., Welling, J., Moilanen, E., & Heinonen, M. (2011). Lingonberry (Vaccinium vitis-idaea) and European Cranberry (Vaccinium microcarpon) Proanthocyanidins: Isolation, Identification, and Bioactivities. Journal of Agricultural and Food Chemistry, 59, 3373-3384.
Lanciotti, R., Corbo, M. R., Gardini, F., Sinigaglia, M., & Guerzoni, M. E. (1999). Effect of hexanal on the shelf life of fresh apple slices. Journal of Agricultural and Food Chemistry, 47, 4769-4776.
Lehtonen, M. I., Teräslahti, S., Xu, C., Yadav, M. P., Lampi, A-M., & Mikkonen, K. S. (2016). Spruce galactoglucomannans inhibit lipid oxidation in rapeseed oil-in-water emulsions. Food Hydrocolloids, 58, 255-266.
Lehtonen, M., Merinen, M., Kilpeläinen, P. O., Xu, C., Willfor, S. M., & Mikkonen, K. S. (2018). Phenolic residues in spruce galactoglucomannans improve stabilization of oil-in-water emulsions. Journal of Colloid and Interface Science, 512, 536-547.
Llorens, E.; Vicedo, B.; Lopez, M. M.; Lapeña, L.; Graham, J. H.; Garcia-Agustin, P. Induced resistance in sweet orange against Xanthomonas citri sub sp. citri by hexanoic acid. Crop Prot. 2015,74, 77-84.
Schaich, K. M., Shahidi, F., Zhong, Y., & Eskin, N. A. M. (2013). Lipid oxidation. In N. A. M. Eskin, & F. Shahidi (Eds.), Biochemistry of Foods (Third edition) (pp. 419-478). Cambridge: Academic Press.
Sholberg, P. L., & Randall, P. (2007). Fumigation of stored pome fruit with hexanal reduces blue and gray mold decay. HortScience, 42, 611-616.
Siedow, J. N. 1991. Plant lipoxygenase: structure and function. Annual Review of Plant Physiology and Plant Molecular Biology, 42, 145-188.
Song, J., Leepipattanawit, R., Deng, W., & Beaudry, R. M. (1996). Hexanal vapor is a natural, metabolizable fungicide: Inhibition of fungal activity and enhancement of aroma biosynthesis in apple slices. Journal of the American Society for Horticultural Science, 121, 937-942.
Song, J., Fan, L., Forney, C., Campbell-Palmer, L., & Fillmore, S. (2010). Effect of hexanal vapor to control postharvestdecay and extend shelf-life of highbush blueberry fruit during controlled atmosphere storage. Canadian Journal of Plant Science, 90, 359-366.
Vicedo, B.; Flors, V.; de la O Leyva, M.; Finiti, I.; Kravchuk, Z.; Real, M. D.; Garcia-Agustin, P.; Gonzalez-Bosch, C. Hexanoic acid-induced resistance against Botrytis cinerea in tomato plants. Mol. Plant. Microbe. Interact. 2009, 22, 1455-1465.

1. A composition comprising a matrix having a lipid phase incorporated therein, wherein the lipid phase comprises an initiator enabling controlled release of oxidation products of lipids from lipids of the lipid phase.

2. The composition according to claim 1, wherein the initiator is a photosensitizer or an enzyme.

3. The composition according to claim 1, wherein the oxidation products of lipids comprise volatile aldehydes, ketones, and acids.

4. The composition according to claim 1, wherein the matrix comprises a porous material, a gel, or a film.

5. The composition according to claim 1, wherein the matrix is a polysaccharide-based aerogel, cryogel, or film.

6. The composition according to claim 1, wherein the matrix is an aerogel or cryogel based on softwood hemicelluloses.

7. The composition according to claim 1, wherein the matrix is a film based on nanofibrillated cellulose.

8. The composition according to claim 1, wherein the lipid phase comprises polyunsaturated lipids.

9. The composition according to claim 1, wherein the lipid phase comprises one or more vegetable oils, or fish oil, optionally in combination with the vegetable oil(s).

10. The composition according to claim 1, wherein the lipid phase comprises sunflower oil.

11. The composition according to claim 1, wherein the lipid phase is mixed with an emulsifier before incorporation into the matrix to obtain an emulsified lipid phase.

12. The composition according to claim 11, wherein the lipid phase is mixed with hemicellulose enriched extracts.

13. The composition according to claim 1, wherein the initiator is a photosensitizer, which is dissolved and dispersed in the lipid phase before incorporation into the matrix.

14. The composition according to claim 1, wherein the initiator is a photosensitizer having a spectral sensitivity which includes the wavelength regions of the visible light spectrum and of ultraviolet rays.

15. The composition according to claim 1, wherein the photosensitizer is a lipophilic photosensitizer or a water soluble photosensitizer.

16. The composition according to claim 1, wherein the initiator is a photosensitizer in an amount of 5-5000 ppm.

17. The composition according to claim 1, wherein the matrix is an aerogel, cryogel, or a film comprising 1-60% lipids, 5-50% hemicelluloses, 5-50% nanofibrillated cellulose, based on the dry weight of the aerogel, or cryogel, or film, and at least one initiator.

18. The composition according to claim 1, wherein the composition is provided in the form of a film, membrane, mat, sheet, plate, patch, layer, coating, lining, package or part of a package, or as foam.

19. An active package or active material for storage of fresh plant products comprising the composition according to claim 1.

20. The package or material according to claim 19, further comprising the composition in an amount sufficient to produce a minimum of 1-20 μmol/l hexanal for at least 10 days.

21. The package or material according to claim 19, further comprising at least 1 g of the composition per 1 litre package or per 1 litre of storage atmosphere.

22. The package or material according to claim 19, further comprising the composition in an amount sufficient to produce at least 300 nmol hexanal per 70 grams of the fresh plant product.

23. The package or material according to claim 19, wherein the package is at least partly transparent.

24. A package comprising fresh plant based goods and the composition according to claim 1.

25. (canceled)

26. A method for continuous in situ production and controlled release of oxidation products of lipids in a package or in the vicinity of fresh plant based goods, the method comprising:
providing a composition according to claim 1; and
incorporating said composition in the package or in a storage space in the vicinity of the fresh plant based goods.

27. The method according to claim 26, wherein the initiator incorporated in the lipid phase of the composition is a photosensitizer and the package or the composition is exposed to visible light or to ultraviolet rays during the storage of the goods in the package.

28. The method according to claim 27, wherein the package or the composition is exposed to visible light or to ultraviolet rays continuously, periodically, or at the beginning of the storage.

29. The method according to claim 26, wherein the composition comprises an enzyme initiator, which is preferably incorporated in the composition at a desired time to initiate oxidation.

30. The method according to claim 29, wherein the enzyme initiator comprises a mixture of lipase and lipoxygenase.

31. (canceled)

32. The composition according to claim 1, wherein the initiator is a lipophilic photosensitizer, a water-soluble photosensitizer, or a mixture of lipase and lipoxygenase enzyme.
